(19) United States
(12) Patent Application Publication
(10) Pub. No.: US 2026/0100189 A1
(43) Pub. Date: Apr. 9, 2026

(54) AUTOMATED ASSISTANT THAT PROACTIVELY INITIATES MODALITY CHANGE DURING CONVERSATION ON BEHALF OF USER

(71) Applicant: GOOGLE LLC, Mountain View, CA (US)

(72) Inventors: Brett Barros, San Mateo, CA (US); Ilana Rozanes, Mountain View, CA (US); Eunice Liu, Zurich (CH); Kimberly Harvey, Los Angeles, CA (US)

(21) Appl. No.: 18/908,335

(22) Filed: Oct. 7, 2024

(51) Int. Cl. G10L 15/22; G10L 15/20

(52) U.S. Cl. CPC G10L 15/22; G10L 15/20; G10L 2015/223; G10L 2015/228

(57) ABSTRACT

Implementations set forth herein relate to an automated assistant that can participate in live conversations on behalf of an entity, and proactively transfer a live conversation to a different modality when a current modality is being interrupted, is expected to be interrupted, or is otherwise hindering performance of task during the live conversation. The automated assistant can determine, for example, that an interruption is occurring based on detected degradation of audio quality or signal quality during the live conversation. In response, the automated assistant can solicit another participating entity to transfer to a separate modality, such as text messaging or other text-based modalities. This transfer can be performed upon express approval from the separate entity, or as a result of the automated assistant proactively sending a text-based message to the separate entity. Information for facilitating such transfers can be determined by the automated assistant during the live conversation.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

In some instances, an automated assistant can be invoked by an entity, such as a person, business, and/or other organization to communicate with a separate entity, in furtherance of performing a particular task (e.g., booking an appointment). However, in response to receiving such a request, the automated assistant may initiate a live conversation with the separate entity using a modality that may not be reliable at the time. For example, a user can request that their automated assistant initiate a cellular audio call to a hotel on behalf of the user, and the call may be subject to periods of sparse connectivity. As a result, automatic speech recognition (ASR) can be inaccurate, which can impact other actions performed on behalf of the user. For instance, when the ASR is inaccurate during crucial portions of the cellular call, each respective entity may come away from the call with different conclusions about information exchanged during the call (e.g., whether the reservation is available, the particular dates to be reserved, times for check-in and check-out, etc.). As a result, the user may need to cancel the request to the hotel and either solicit their automated assistant to redo the requested operation, or create the booking without the automated assistant.

Either way, the inability of the automated assistant to adapt unexpected issues with connectivity, background noise, etc. can result in duplicative efforts to perform common tasks, thereby wasting processing bandwidth and other computational and/or network resources. Furthermore, when each entity is involved in activities that affect a population of devices and/or persons, this inability of automated assistants to adapt to certain communication issues can lead to issues that may be proportional to the population that is affected. For example, erroneous actions such as confirming the wrong address for a delivery, ordering the wrong food for pick-up, and agreeing to a meeting time during which one entity is unavailable, can cause multiple persons, devices, and/or applications to unnecessarily waste time and resources on tasks.

### SUMMARY

Implementations set forth herein relate to an automated assistant or other application that can initiate communications with a separate entity on behalf of an initiating entity, such as a user, group of users, business, group of applications, and/or any other entity that can interact with an automated assistant. In particular, the implementations set forth herein provide for an automated assistant application, or other application, that can proactively suggest transitioning a live conversation from one modality to another modality in a variety of different circumstances. For example, a user can request that the automated assistant communicate with a separate entity on behalf of the user via audio or video conference. During the requested audio or video conference, the automated assistant application can proactively determine to transition to another modality, such as SMS messaging, or another text-based message modality, because of an issue with the live conversation (e.g., an issue with audio quality, image quality, resolution of data, network bandwidth, processing bandwidth, inability to accurately process audio data during the audio or video conference, etc.). Based on this determination, the automated assistant can process certain information for determining whether the separate entity can receive text-based messages and/or otherwise readily transition to a text-based conversation. When the automated assistant determines that the separate entity can make such a transition, the automated assistant application can optionally provide a message to the separate entity for confirming this transition.

Alternatively, or additionally, the automated assistant application can proactively initiate the transition to a text-based message conversation without express confirmation from the separate entity (but with express permission from any users involved or otherwise affected by the conversations).

In some implementations, the automated assistant application can determine to transition to another modality for live conversation based on quality issues with the initial live conversation. For example, quality of automatic speech recognition (ASR) can be determined during the live conversation. Notably, ASR can include preprocessing an audio input to a computing device, which captures the speech from the person with whom the user is interacting. The preprocessing operation can remove noise, enhance the audio, and/or normalize the volume of the audio input data such that further extraction of audio features can be performed. In some implementations, one or more acoustic model (e.g., hidden Markov models (HMMs), Gaussian mixture models (GMMs), and deep neural networks (DNNs)) can be used to map the audio features into the corresponding units of sound for a language, such as phonemes. When the phonemes have been mapped, a language model can be utilized to generate the most probable sequence of words given the phoneme sequence generated by the acoustic model. For example, candidate sequences can be generated using statistical models, such as n-grams, or neural network models, such as recurrent neural networks (RNNs) and/or transformers. In some implementations, any recognized text can be rendered for the user in real-time, thereby allowing a recipient of the speech, and user of the application, to reference a literal translation of the speech from the other person or a summary of a literal translation of the speech from the other person.

In some implementations, the quality of the ASR can be determined based on a degree of similarity between an expected ASR result and an actual ASR result (e.g., based on an edit distance between the expected ASR result and the actual ASR result, based on phonetic similarity between the expected ASR result and the actual ASR result, etc.). When this degree of similarity does not satisfy a threshold degree of similarity, an interference can be determined to affect an ability of the automated assistant to interpret a live conversation. In some additional or alternative implementations, when a score or other metric representing the quality does not satisfy a threshold value, the automated assistant application can initiate transitioning from the initial modality of the live conversation to another modality for the live conversation. For instance, the initial live conversation can be via telephone audio, and the target modality for transitioning the conversation can be SMS messaging, or another text-based messaging protocol. In such instances, other factors can influence a transition between those modalities. For example, connectivity, image resolution, and/or network bandwidth can be determined such that, when any score or metric for the connectivity or network bandwidth does not satisfy a threshold value, the automated assistant application can initiate transitioning from an audio or video-based modality to a modality that may consume a reduced amount of network bandwidth, or may not otherwise cause the same degree of communication and/or connectivity issues.

In some implementations, the automated assistant application can determine an ability of the separate entity to transition to a different modality by processing available data associated with the separate entity, with prior permission from the separate entity. For example, a user may request that the automated assistant application initiate a phone call with a business using a particular phone number. However, the automated assistant may not initially be aware of whether the phone number can receive SMS messages or other text messages. Therefore, in response to receiving the request from the user, and/or in response to detecting any issues with the initially requested modality, the automated assistant application can determine whether the separate entity can receive SMS messages or other text messages via the phone number or another address. For example, a publicly available business profile or other profile for the separate entity can be available via the internet or a separate application. Content from the profile can indicate the separate entity can receive SMS messages or other text-based messages via a particular address or interface (such as a chatbot on a website for the separate entity). Based on processing this content, the automated assistant application can use a separate phone number, or separate address or interface, to transition the initial live conversation to a separate modality or separate channel of the same modality. For example, when a separate phone number is associated with the separate entity, and when information on a public webpage indicates the separate phone number can receive SMS messages, the automated assistant application can provide an SMS message to the separate entity for continuing the live conversation. In some implementations, the message can include a summary of the live conversation thus far, a transcript of the live conversation thus far, and/or a request to confirm that the separate entity is available to continue the live conversation. Although the above functionality is described with respect to an example of the user initiating the phone call with the business, it should be understood that is for the sake of example and is not meant to be limiting. For example, the same or similar functionality can be utilized to determine whether to transition to a different modality in examples where the business initiates the phone call with the user (e.g., to confirm a restaurant reservation or the like).

In some implementations, a message provided by the automated assistant application for indicating the transition of the live conversation can include one or more suggestions for providing requested information to the automated assistant application. For example, when the user initially solicited the automated assistant to initiate the live conversation with the separate entity, the user may have wanted to book an appointment with the separate entity. However, because of some interference with the live conversation, the automated assistant application may not have been able to confirm the time and date for the appointment. In response to this circumstance, the automated assistant application can provide one or more selectable suggestions in the text message provided in furtherance of transitioning the live conversation. The selectable suggestions can include, for example, a request for the separate entity to select to confirm a particular appointment date and time, a request for the separate entity to select a particular date and time from a list of date and times, and/or request for the separate entity to select a subsequent date and time to continue the live conversation. In some implementations, the suggestion for continuing the live conversation at a subsequent date and/or time is provided via text message modality, the original modality for the live conversation, and/or any other modality suitable for the separate entity and/or the automated assistant. In this way, by providing such functionality for various entities and/or automated assistants, more accurate interactions can occur. When accuracy of such interactions is improved, the number of duplicative interactions can be decreased, thereby reducing waste of computational resources (e.g., power, processing bandwidth, etc.) for populations of devices, and making more efficient use of such resources.

The above description is an overview of some implementations of the present disclosure. Further description of those implementations, and other implementations, are described in more detail below. Still other implementations may be claimed.

### BRIEF DESCRIPTION OF THE DRAWINGS

FIG. 1A, FIG. 1B, FIG. 1C, FIG. 1D, and FIG. 1E illustrate views of a user interacting with an automated assistant in furtherance of causing the automated assistant to participate in a live conversation on behalf of the user.

FIG. 2 illustrates a system that provides access to an automated assistant or other application that can initiate communications with a separate entity on behalf of an initiating entity, such as a user, group of users, business, group of applications, and/or any other entity that can interact with an automated assistant.

FIG. 3 illustrates a method for facilitating an ability of an automated assistant application to initiate conversations on behalf of a user and transition those conversations to another modality in certain circumstances.

FIG. 4 is a block diagram of an example computer system.

### DETAILED DESCRIPTION

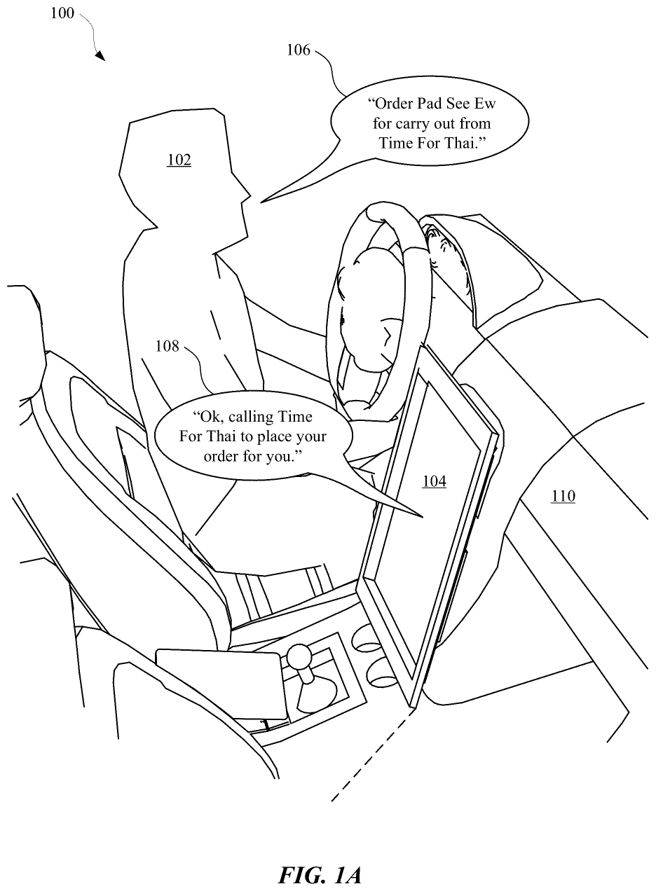

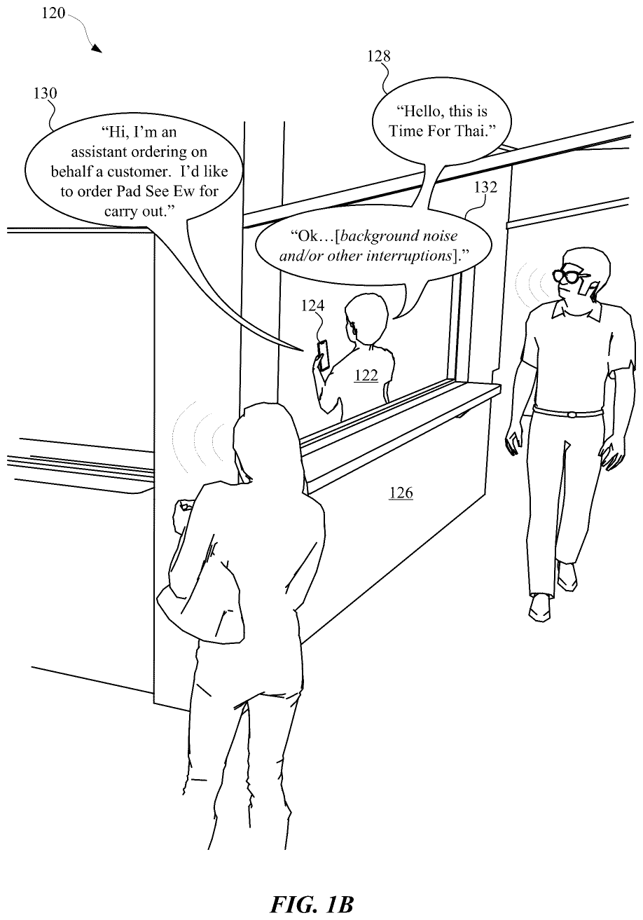

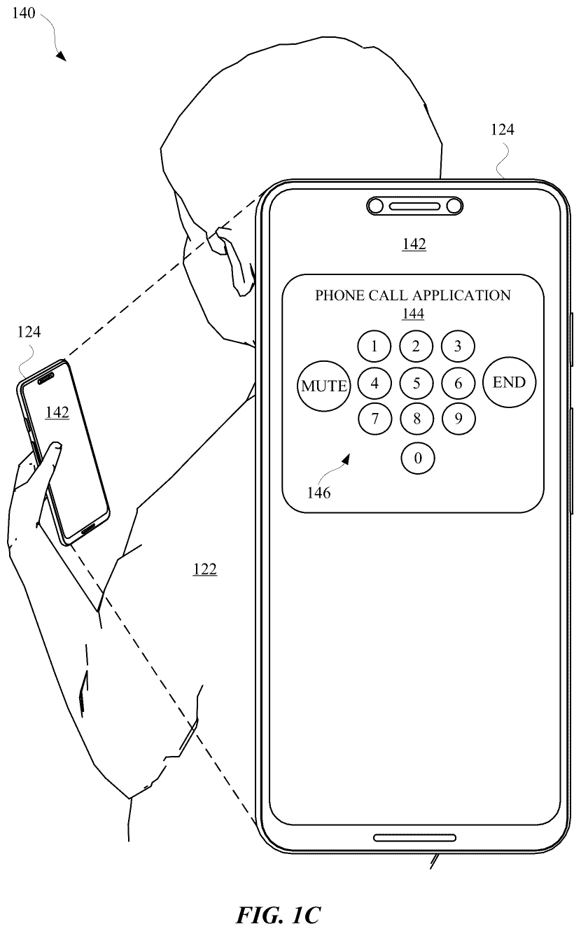

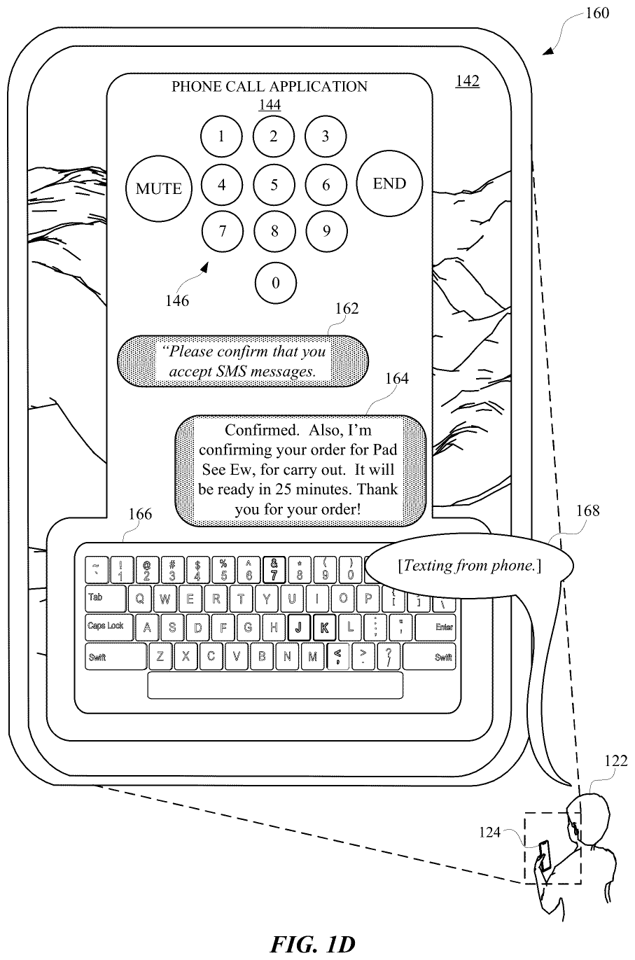

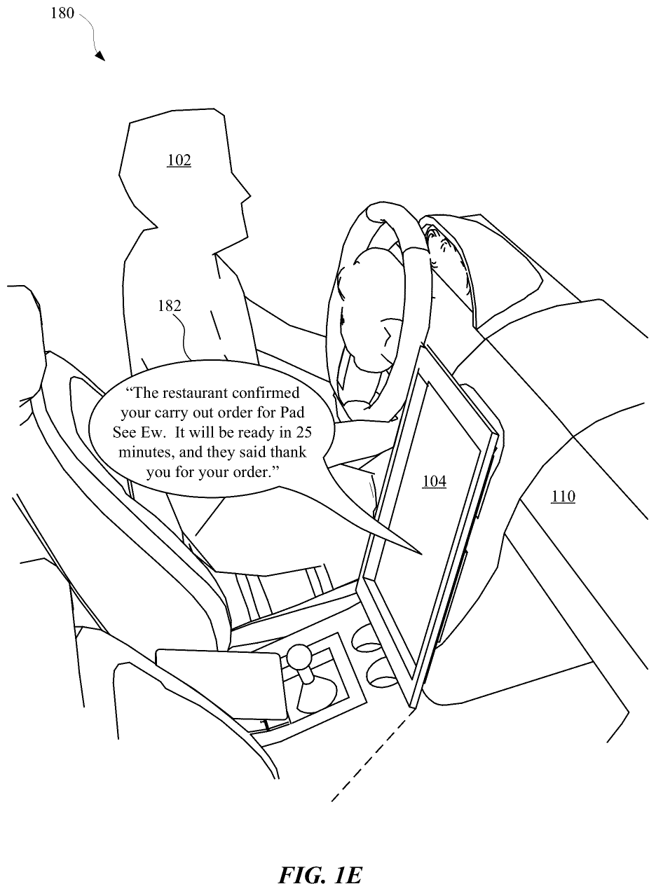

FIGS. 1A, 1B, 1C, 1D, and 1E illustrate views 100, 120, 140, 160, and 180, respectively, of a user interacting with an automated assistant in furtherance of causing the automated assistant to participate in a live conversation on behalf of the user 102. During the live conversation, the automated assistant can proactively request that the live conversation be transferred to another modality, such as text, audio, video, and/or any other suitable modality. Such a request can be proactively initiated by the automated assistant when a live conversation is being interrupted and/or is estimated to be interrupted, thereby resulting in a potential inability for the automated assistant to fulfill a request from the user 102.

As one illustrative example, FIG. 1A illustrates a view 100 of a user 102 interacting with an automated assistant that is accessible via a computing device 104 in a vehicle 110. In this instance, the user 102 can interact with the automated assistant in furtherance of causing the automated assistant to place an order at a restaurant on behalf of the user 102. For example, the user 102 can provide a spoken utterance 106 such as, “Order Pad See Ew for carryout from Time for Thai.” In response to this spoken utterance 106, the automated assistant can initiate one or more operations in furtherance of fulfilling one or more requests embodied in the spoken utterance 106. The automated assistant can acknowledge that the one or more operations are being initiated by providing a responsive output 108. The responsive output 108 can be, for example, “Okay, calling Time for Thai to place your order for you.”

In response to receiving the spoken utterance 106, the automated assistant can initiate a phone call to an entity 126, such as a restaurant that the user 102 can drive to in their vehicle 110. In some implementations, the automated assistant can identify contact information for the entity 126 by searching the internet, accessing contact information associated with the user 102 with prior permission from the user, and/or otherwise access data that can indicate contact information for various entities with prior permission from those entities. As illustrated in view 120 of FIG. 1B, an employee 122 or other agent of the entity 126 can receive a phone call at a computing device 124. The computing device 124 can have a phone number that is associated with the entity 126, thereby allowing live conversations with the entity 126 to be facilitated via the computing device 124. The employee 122 can answer the phone call from the automated assistant with an initial spoken utterance such as, “Hello, this is Time for Thai.” The automated assistant can process audio data capturing the initial spoken utterance 128 in furtherance of determining the proper response to provide on behalf of the user 102.

For example, the automated assistant can provide a responsive spoken utterance 130 such as, “Hi, I'm an assistant ordering on behalf of a customer. I'd like to order Pad See Ew for carryout.” This responsive spoken utterance 130 can be generated using a large language model (LLM) or other generative model for providing natural language output for continuing a live conversation. The LLM or other generative model described herein can be any sequence-to-sequence based machine learning model capable of generating generative vision data, generative audio data, generative textual data, and/or other forms of generative data. Some non-limiting examples of these sequence-to-sequence based machine learning models that are capable of generating one or more forms of the generative data noted above include transformer-based machine learning models (e.g., encoder-decoder transformer models, encoder-only transformer models, decoder-only transformer models, etc. that optionally employ an attention mechanism or some other form of memory), stable diffusion-based machine learning models, recurrent neural network-based machine learning models, generative adversarial network-based machine learning models, etc. Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models. In some implementations, the LLM or other generative model can process the initial spoken utterance 128 to generate the responsive spoken utterance 130 (e.g., audio in-audio out). In additional or alternative implementations, the LLM or other generative model can process an ASR result for the initial spoken utterance 128 to generate textual content that is then synthesized into the responsive spoken utterance 130 (e.g., text in-text out).

Referring back to view 120 if FIG. 1B, although the computing device 124 may receive the audio from the automated assistant, and even play back the audio, a response from the employee 122 may be interrupted by background noise or other interruptions such as network connectivity issues. In some implementations, these interruptions can be detected by the automated assistant, the computing device 124, the computing device 104, and/or any other application or apparatus associated with the automated assistant, with prior permission from any participant to the live conversation.

For example, the background noise may be due to other persons walking by the entity 126 and/or persons inside of a restaurant chatting normally in the background. In some implementations, the automated assistant may request that the live conversation be transferred from an audio conversation to a text-based conversation. Alternatively, or additionally, in some implementations, the automated assistant may perform preventative measures to reduce the negative effects of any interruptions on the live conversation. For example, the automated assistant can cause some amounts of filtering, compression, and/or other audio processing to be performed to improve an ability of the automated assistant to interpret a subsequent spoken utterance 132 from the employee 122. However, when such optional preventative measures are determined to be ineffective, the automated assistant can provide an optional request to the entity to continue the conversation via a different modality than a current modality of the live conversation.

For example, and as illustrated in view 140 of FIG. 1C, the employee 122 can communicate with the automated assistant via the computing device 124. The computing device 124 can include a display interface 142, as well as a phone call application 144 with GUI elements 146 for providing other inputs to the phone call application 144 or the computing device 124. As the employee 122 is engaging with the automated assistant via the computing device 124, the automated assistant can cause a notification to appear at the display interface 142, as shown in view 160 of FIG. 1D. For example, the automated assistant can determine that the contact information for the entity 126 corresponds to a phone number that can receive SMS messages, or some other address or application that the entity 126 can be contacted at using text-based messages. Alternatively, or additionally, the automated assistant can determine that a website associated with the entity 126 indicates that customers may send text-based messages to the entity 126. Based on this information, the automated assistant can provide a text-based message 162 to the entity 126. The text-based message 162 can include content such as, “Please confirm that you accept SMS messages.” Alternatively, or additionally, the automated assistant can provide an alternative text message that indicates the automated assistant is attempting to continue the live conversation via text messaging. In some implementations, a text message from the automated assistant can include contextual information to refresh a recollection of the entity 126, such that the entity 126 will have a reference to the prior live conversation that was interrupted. In some implementations, the notification can be an audible tone and/or a push notification.

In response to receiving the text-based message 162 from the automated assistant, the entity can use a text input interface 166 or another interface to provide a responsive text-based message 164 to the automated assistant. In some implementations, as the employee 122 initiates their text-based message 168, the automated assistant can provide an optional notification to the user 102 that the live conversation is being continued via text message because of a detected interruption. When the employee 122 has confirmed or otherwise responded to the initial text-based message 162 from the automated assistant, the responsive text-based message 164 can be communicated to the user 102. For example, text of the responsive text-based message 164 can be summarized or otherwise communicated to the user 102 through text messaging at their computing device 104 or via audio at the computing device 104, or any other device associated with the user 102.

For example, FIG. 1E shows a view 180 of the user 102 receiving an audible output from the automated assistant. The audible output 182 can be a summary of the responsive text-based message 164 from the entity 126. In some implementations, the audible output 182 can be generated using an LLM or other generative model (e.g., described above) to generate natural language text from the responsive text-based message 164. Thereafter, the generated text can be converted to the audible output 182 using one or more models for performing text-to-speech (or directly using the LLM or another generative model as described above). By allowing the automated assistant to transfer live conversations between modalities, significant time and resources can be preserved by reducing a number of instances in which a live conversation must be rescheduled or restarted because of background noise or other interruptions. For example, when such live conversations are performed all over again, network bandwidth can be duplicatively consumed on exchanges of information that have already occurred. Additionally, when such live conversations are not transferred to a different modality prior to such exchanges, despite a different modality being available, the automated assistant would effectively be making inefficient use of other modalities of communication that are available to continue the conversation to avoiding wasting the interaction, such as SMS messaging, email messaging, and/or any other available messaging modality. Furthermore, as businesses and other entities start to adopt their own versions of automated assistants, the ability for live conversations to be transferred to other modalities can promote the compatibility of different automated assistants. For example, an automated assistant that answers phones on behalf of a human can nonetheless treat a phone call from another assistant like they would a phone call from a human. Therefore, when such a phone call is interrupted by background noise or network issues, the automated assistant can transfer their live conversation to a different modality without requiring any further protocol for exchanging information between different assistants.

Although the example depicted throughout FIGS. 1A-1E is described with respect to transferring the live conversation between modalities, it should be understood that is for the sake of example and is not meant to be limiting. In additional or alternative implementations, the quality of the ASR during the live conversation or any other factor that influences the transition between the modalities can be utilized to determine to transfer the live conversation to a local agent (e.g., automated assistant) of the computing device 104 of the user 102 that can continue the live conversation on behalf of the entity 126. In these implementations, the local agent of the computing device 104 of the user 102 can gather information related to a topic of the conversation and then provide that information to the entity 126 in an asynchronous manner (e.g., when the computing device 104 is connected to WiFi, when the computing device 104 has connectivity that satisfies a threshold, etc.). Further, in these implementations, the local agent can provide that information to the entity 126 in a manner such that it appears the asynchronous resumption of the live conversation is occurring in real-time. For instance, audio data can be synthesized and rendered for the entity 126, but appear as if it is sped up to re-contextualize the live conversation for the user 102 and/or the entity 126.

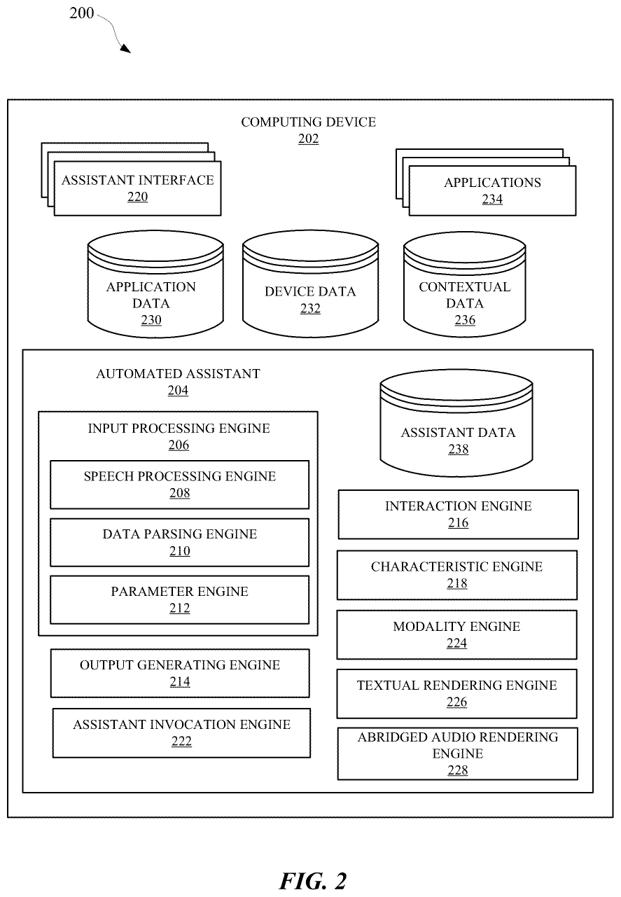

FIG. 2 illustrates a system 200 that provides access to an automated assistant 204 or other application(s) 234 that can initiate communications with a separate entity on behalf of an initiating entity, such as a user, group of users, business, group of applications, and/or any other entity that can interact with an automated assistant. For example, the automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi® network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data and using an ASR model. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include an ASR algorithm, which can employ neural network model(s) (e.g., ASR model(s)), and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device ASR, on-device natural language understanding, and on-device fulfillment. For example, on-device speech recognition can be performed using an on-device ASR module that processes audio data (detected by the microphone(s)) using an end-to-end ASR machine learning model stored locally at the computing device 202. The on-device ASR module generates recognized text for a spoken utterance (if any) present in the audio data. Also, for example, on-device natural language understanding (NLU) can be performed using an on-device NLU module that processes recognized text, generated using the on-device ASR, and optionally contextual data, to generate NLU data.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device speech processing, on-device NLU, on-device fulfillment, and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases or utterances from a user based on features of a context and/or an environment. Additionally, or alternatively, the assistant invocation engine 222 can cause the automated assistant 204 to detect, or limit detecting for one or more assistant commands from a user based on features of a context and/or an environment. In some implementations, the assistant invocation engine 222 can be disabled or limited based on the computing device 202 detecting an assistant suppressing output from another computing device. In this way, when the computing device 202 is detecting an assistant suppressing output, the automated assistant 204 will not be invoked based on contextual data 236—which would otherwise cause the automated assistant 204 to be invoked if the assistant suppressing output was not being detected.

In some implementations, the system 200 can include an interaction engine 216 that can manage translation processes and/or any other interactions between the user, a bystander, and/or the system 200. For example, the interaction engine 216 can act as a mediator between the automated assistant 204 and a user or other entity, thereby processing inputs from another entity to the automated assistant 204 and translating them for rendering to a user or entity (e.g., a user who has invoked the automated assistant 202 to communicate with another entity on behalf of the user). In some implementations, the interaction engine 216 can also mediate different components including a speech recognition module, a translation engine, a text-to-speech synthesis module, and/or an audio playback module. In some implementations, the interaction engine 216 can receive the audio input of a user or other entity (with prior permission) for a preprocessing stage. The preprocessing stage can be conducted to enhance the audio quality and/or remove any background noise, using techniques such as audio normalization, echo cancellation, and/or noise filtering. The preprocessed audio input can be then analyzed using ASR to recognize and convert any spoken words from audio to text. As described herein, such conversion can involve the use of machine learning models or tools, such as hidden Markov models, neural networks, and/or deep learning algorithms. The text output from speech recognition can be then analyzed using language models, character n-grams, and/or statistical models to identify portions of text. The interaction engine 216 can use machine translation to translate the spoken input into a target language, using techniques such as neural machine translation, rule-based translation, and/or statistical translation.

In some implementations, the interaction engine 216 can abridge the translated text into shorter text (i.e., translated speech data) that would be played back as an abridged audio translation, or into longer text that would be played back as an extended audio translation (e.g., to account for contextually relevant breaks in speech such, for laughter, gestures, and/or any other breaks to be accounted for to promote fluid conversation). For example, the translation interaction engine 216 can use an LLM or other generative model described herein to generate a summary of the non-abridged translated speech data, which would be based on various techniques, such as extractive summarization and/or abstractive summarization. In some implementations, a degree of summarization for providing an abridged version of a translation can be manually controlled by a user (e.g., via a GUI interface) and/or through automatic selection by the application for a given context, user, and/or other feature of a given conversation.

In extractive summarization, the algorithm selects the relevant sentences or phrases from the original text to form a summary. Techniques used in extractive summarization include LLMs or other generative models, frequency analysis, cosine similarity, and/or graph-based methods. In contrast with extractive summarization, in abstractive summarization, the algorithm generates a summary that can include new phrases or sentences not present in the original text. Techniques used in abstractive summarization involve deep learning models such as LLMs or other generative models, recurrent neural networks, transformers, and/or pointer-generator networks. The abridged summary can then be synthesized into an abridged audio translation using text-to-speech (TTS) synthesis techniques. In some implementations, a TTS process can use either rule-based and/or machine learning-based approaches to generate speech from text.

For example, a rule-based TTS process can use pre-defined pronunciation rules and synthesis algorithms, and a machine learning-based TTS process can use neural networks to learn a mapping between text and speech. In other implementations, audio data that captures the abridged summary can be generated directly using some machine learning models described herein (e.g., multimodal generative models)

When an abridged audio translation has been generated, this abridged translated audio can be played back to the user or other entity through an audio interface, which can allow the user to listen to a shorter summary of the translated text. In some implementations, the interaction engine 216 can also manage user interactions by choosing the target language, adjusting parameters of the audio playback, and/or adjusting the length and/or the tone of the obtained textual translation. In some implementations, a more detailed textual translation of the spoken input can be generated by the interaction engine 216 as well, using context-aware language modeling and/or other phrase-based machine translation techniques, depending on the preferences of the user.

In some implementations, the system 200 may include a characteristic engine 218 that can analyze and/or determine the translation quality and/or other characteristics of a translation generated using an ASR model or other machine learning model described herein. The characteristic engine 218 can analyze and evaluate various aspects of the translation output, such as accuracy, fluency, readability, coherence, and/or provide feedback and/or a score or other metric to indicate quality of the translation. For example, the characteristic engine 218 can evaluate the quality of the translation output (text translation and/or audio translation) based on various metrics. In some implementations, a metric can include a word error rate (WER), which can characterize the accuracy of the translation output by indicating (e.g., using techniques such as dynamic time warping and/or Levenshtein distance) a percentage of words that are incorrectly translated and/or not translated at all. Another metric can include a language model perplexity, which can indicate fluency and/or coherence of the translation output. In some implementations, techniques such as n-gram language modeling or recurrent neural networks can be utilized to determine fluency and/or coherency (e.g., how well a language model predicts the next word in a sentence based on the previous words). In some implementations, readability scores can also quantify the quality of the translation, by assessing the clarity and comprehensibility of written material, and/or using techniques such as the Flesch-Kincaid readability test and/or the Gunning fog index.

In some implementations, the characteristic engine 218 can also analyze the translation output for various characteristics such as grammar and vocabulary according to different techniques. For example, part of speech tagging (POS) would allow to analyze the grammar and syntax of the translation output, by labeling each word in a sentence with a corresponding POS (e.g., noun, verb, adjective, etc.) using techniques such as hidden Markov models and conditional random fields. Another example would be performing vocabulary analysis, by comparing the translation output to a bilingual lexicon for example, to identify any errors or inconsistencies in the vocabulary and ensure that the words are appropriate and accurate. In some implementations, the characteristic engine 218 can rely on word embeddings and term frequency-inverse document frequency (TF-IDF) for vocabulary analysis. The characteristic engine 218 can also analyze the style of the translation output to ensure that the style of the translation output is consistent with any intended tone, using techniques such as sentiment analysis. Alternatively, or additionally, grammar analysis can be performed using parsing techniques, such as dependency parsing and/or constituency parsing, in furtherance of ensuring the translation output is grammatically correct.

In some implementations, the recognized speech can be matched with an existing language model using techniques such as, but not limited to: hidden Markov models (HMMs) for detecting and recognizing phonemes, words, or sentences; deep neural networks (DNNs) for modeling and matching the speech input with the corresponding language output; Gaussian mixture models (GMMs) for modeling the distribution of acoustic features of speech sounds based on statistical and/or probabilistic criteria; and/or using convolutional neural networks (CNNs), in addition to modeling and matching speech sounds with recurrent neural networks (RNNs).

In some implementations, the characteristic engine 218 can combine the various metrics and generate an overall quality score for the translation output using a weighted scoring system. The weights can be assigned based on the importance of each metric for the particular application and/or domain. For example, weighted scoring can allow the system 200 to provide feedback to the interaction engine 216 based on the overall quality score, in order to improve the translation model by adjusting the weights and/or updating the language model. Additionally, or alternatively, the weighted scoring can provide some recommendations to improve the translation quality as well, such as suggesting alternative translations or tones, and/or pointing out ambiguities or other errors.

In some implementations, data generated by the characteristic engine 218 can be accessed by a modality engine 224 for determining whether to suggest that an interaction between an automated assistant 204 and another entity should be transferred to a different modality. For example, when a score or other metric generated by the characteristic engine 218 indicates that a quality of a translation of audio to text, or text to audio, does not satisfy a quality threshold, the modality engine 224 can cause the automated assistant 204 to initiate a change in modality. In some implementations, the modality engine 224 can provide an indication of the modality change output generating engine 214 to cause the automated assistant 204 to provide an output to the entity regarding the modality change. The output can include natural language content (e.g., generated using an LLM (or other generative model) and based on existing content of a conversation with prior permission from all participants) that indicates the context for the change in modality and/or how to transfer from the current modality to a different modality.

In some implementations, the modality engine 224 can pre-emptively detect one or more other modalities available to the other entity that is participating in an interaction or live conversation with the automated assistant 204. Detecting other available modalities can include accessing data associated with the other entity, with prior permission from the other entity, and/or otherwise requesting data that can provide an indication of any other modalities available to the other entity, with prior permission from the other entity. For example, a public website can provide an indication of the various modalities that another entity (e.g., an airline company) can communicate through. Therefore, when a quality of a current interaction does not satisfy a particular threshold value, the automated assistant 204 can proactively initiate transitioning from the current modality to the other available modality.

In some implementations, the system 200 can include a textual rendering engine 226 that can control the display of the translated text on a user interface (e.g., when a modality of an interaction is changed from audio to text messaging). The textual rendering engine 226 can take the translated text output and render this translated text output in a user-friendly format at, for example, the display interface 142 for the other entity. The textual rendering engine 226 can optionally format the translated text in a user-friendly format, which can involve editing a variety of parameters, such as the font size, style, and/or color of the text. The textual rendering engine 226 can also add other formatting elements if necessary, such as spaces, line breaks, and headings. In some implementations, the textual rendering engine 226 can adapt the rendered text to the user interface, depending on different features of the display interface 142, such as the display size and resolution. Additionally, or alternatively, the textual rendering engine 226 can provide the user with options for customizing the display of the translated text, such as adjusting the font size and color, and/or choosing a different language display mode. In some implementations, the user can have the option to reference the textual translation when needed by interacting with a touch interface of a computing device and/or providing any other input to a device.

In some implementations, natural language processing (NLP) techniques can be utilized to summarize translated text. For example, NLP can involve analyzing the content of the text and identifying information, on which the creation of a summary would be based. Some NLP techniques can include latent semantic analysis (LSA), TextRank, latent Dirichlet allocation (LDA), and/or utilization of an LLM or other generative model described herein. Alternatively, or additionally, the application can allow the user to manually set some summarization parameters (e.g., using an interactive GUI element such as a dial or button), such as a desired length of the abridged text, and/or seeking feedback from the user about the quality of the obtained summary. This feedback can then be utilized to enhance any available learning algorithms or machine learning models, thereby allowing the application to learn from the previous actions and/or queries of the user, and adjust any model parameters accordingly.

In some implementations, the system 200 can include an abridged audio rendering engine 228 that can generate and/or cause playback of the abridged audio translation. The abridged audio rendering engine 228 can utilize one or more text summarization techniques to reduce a length of the translated text, while keeping important details and/or summarizations. For example, the abridged audio rendering engine 228 can utilize extractive summarization and/or abstractive summarization. In some implementations, the abridged audio rendering engine 228 can perform disfluency detection and removal from the translated text, using natural language processing techniques such as POS tagging, dependency parsing, and/or named entity recognition. These techniques can be utilized to identify disfluencies such as stuttering, false starts, and/or repetitions. In some implementations, disfluency detection can be performed using regular expressions by searching for patterns of disfluencies, and optionally further training machine learning models to recognize disfluencies within a given text and distinguish them from quality issues (e.g., background noise, microphone issues, etc.). When identified, a disfluency removal process and/or correcting process can be performed according to one or more heuristic processes, machine learning approaches, statistical methods, and/or any other suitable approach.

In some implementations, the abridged audio rendering engine 228 can convert abridged text into an audio file, using text-to-speech (TTS) synthesis technology, thereby creating an audio translation with a synthetic voice for the audio playback. For example, a text message received from another entity can be converted using TTS synthesis, thereby allowing the user to continue to interact with their automated assistant 204 via an audio interface (e.g., a standalone speaker device), despite the interaction between another entity and the automated assistant 204 transitioning from an audio modality to a text modality. In some implementations, the abridged audio rendering engine 228 can provide audio-editing tools, allowing a user to adjust the speed, volume, and/or pitch of the audio playback to match the preferences of the user and/or otherwise ensure the synthesized speech is clear and understandable. The abridged audio rendering engine 228 can optionally encode the synthesized speech into a format (e.g., MP3, ACC, etc.) that is suitable for playback on a device and/or transfer to another device. Although a series of models, or cascade of systems, can be utilized to convert an audio speech input to an abridged audio output, the system 200 can also employ a single model or system to convert an instance of input audio speech data to abridged audio output data according to any suitable language model.

FIG. 3 illustrates a method 300 for facilitating an ability of an automated assistant application to initiate conversations on behalf of a user and transition those conversations to another modality in certain circumstances. The method 300 can be performed by one or more applications, devices, and/or any apparatus or module capable of interacting with an automated assistant. The method 300 can include an operation 302 of determining whether an entity, such as a person or organization, has provided a request to an automated assistant for initiating a live conversation with a separate entity. The separate entity can also be a separate person, separate organization, and/or a separate application or device.

For example, a user can provide a request to an automated assistant application for initiating a phone call on behalf of the user. The user can direct the automated assistant to call a nearby organization, such as a business, to schedule an appointment, order a product, and/or otherwise communicate some amount of information with the separate entity. The request can be received at a client device, such as a cellular phone of the user, thereby allowing the automated assistant application to initiate a cellular phone call on behalf of the user, and with prior permission from the user. For example, the request from the user can be, “Assistant, call the neighborhood flower business to arrange for pickup of a dozen roses today by 4:00 p.m. today.”

When a request for initiating the live conversation has been received, the method 300 can proceed from the operation 302 to an operation 304. Otherwise, the automated assistant application, or other application performing the method 300, can continue to determine or otherwise detect requests. The operation 304 can include causing the separate entity to receive a notification regarding the request to participate in the live conversation. For example, when the separate entity is a person, the person can receive a notification on their own cellular phone, which they may be used for, or otherwise associate with, their business or organization.

The notification may be rendered by a corresponding assistant application, a separate application, and/or any other interface or modality for providing notifications to a user. In some implementations, the operation 304 can be optional, such that a separate entity may automatically accept such requests from users or entities from their respective automated assistance. When the separate entity receives the notification regarding the live conversation, the separate entity may be joined into the live conversation as a participant, with prior permission from the separate entity. Alternatively, or additionally, the separate entity may be joined into the live conversation as a participant only after expressly confirming their willingness to participate in the live conversation.

The method 300 can proceed from the operation 304 to an operation 306, which can include determining whether quality or other features of the live conversation is being negatively affected. For example, during the live conversation, an amount of background noise at the side of the requesting party and/or the separate entity can be determined. When the determined amount of background noise, and/or other quality metric or score, satisfies a threshold value, the method 300 can proceed from the operation 304 to an operation 310. Alternatively, or additionally, the quality being determined for the live conversation can include network connectivity, processing and/or power availability, accuracy of ASR, conflicts with other applications and/or users, and/or any other feature or property that can affect a live conversation. Any of these features and/or qualities can be processed heuristically and/or using one or more trained machine learning models for determining whether to continue to the operation 310 or to an operation 308. For example, when the automated assistant application determines that a quality or qualities of the live conversation are not being negatively affected to a particular degree, or otherwise to a degree that satisfies one or more requirements, the method 300 can proceed to the operation 308.

The operation 308 can include causing the automated assistant application to continue the live conversation in furtherance of fulfilling the request from the user or requesting entity. In other words, the automated assistant application may not attempt to transition the live conversation to another modality until certain features or properties are exhibited during the live conversation. However, when such features and/or properties are exhibited, the method 300 can proceed from the operation 306 to the operation 310. The operation 310 can include determining whether the separate entity is capable of transitioning to a separate modality for continuing the live conversation.

In some implementations, the separate modality can be one or more different modalities. For example, a separate modality can include text-based messaging from the same device or a different device from which the request to the automated assistant was received. Alternatively, or additionally, the separate modality can include an audio modality, text modality, video modality, and/or any other modality for communicating during a live conversation. As a continuation of the previous example, the automated assistant application can determine whether the neighborhood flower business can communicate via SMS messaging. In some implementations, this determination can be determined by the automated assistant during the live conversation by causing the automated assistant application to audibly ask a person or assistant application representing the separate entity to confirm whether SMS messaging is acceptable. Alternatively, or additionally, the automated assistant can communicate with a server device or other apparatus for causing a push notification to be received by the separate entity, in furtherance of confirming whether the separate entity can receive SMS messages. Alternatively, or additionally, the automated assistant application can search the internet, or use other applications, with prior permission from the separate entity, to determine whether the separate entity has any address, phone number, and/or other contact information through which to communicate via a different modality.

Furthering the aforementioned example, consider that the neighborhood flower business may have a website or other social media profile that indicates they can receive text messages through a particular phone number and/or through a chatbot or other application. Based on this determination, and based on the quality of the live conversation being negatively affected, the automated assistant may proceed with transitioning the current live conversation to a separate modality. When the automated assistant determines that the separate entity may not be able to transition the live conversation to a separate modality, the method 300 can proceed from the operation 310 to an operation 312.

The operation 312 can be an optional operation that includes performing one or more corrective operations for improving a quality, property, and/or other feature(s) of the live conversation. In other words, because the automated assistant may not be able to transition the live conversation when the quality is being negatively affected, the automated assistant application can nonetheless attempt to improve the quality. Some operations that the automated assistant application can cause to be performed can include, but are not limited to, filtering, compressing, reconnecting, providing notifications (e.g., “Could you disconnect from Bluetooth? I'm having trouble hearing you.”), and/or taking any other corrective action for improving the quality of the live conversation. Thereafter, the method 300 can proceed from the operation 312 to the operation 308. Otherwise, when the separate entity is determined to be capable of transitioning to a separate modality, the method 300 can proceed from the operation 312 to an operation 314. In other implementations, the operation 312 may be continuously performed during, for example, the operations of block 306 to enhance the quality of communications described herein.

The operation 314 can include providing a message to the separate entity via another modality for continuing the live conversation. The other modality can be any modality that is different from a prior modality with which the live conversation was being conducted. The message can be any information that is communicated over the other modality, such as some amount of text, audio, video and/or any other type of message. For example, the live conversation can be initiated over audio but can be transitioned to text messaging. Alternatively, or additionally, the live conversation can be initiated over video (e.g., a generative avatar can represent the automated assistant) but can be transitioned to another modality that includes audio and/or text messaging. In the aforementioned example, the automated assistant application can communicate through an audio phone call with the neighborhood flower business and transition to SMS messaging with the neighborhood flower business. In this way, the request from the user can be fulfilled despite the quality of the initial live conversation being negatively impacted by things that may be out of the control of the automated assistant, the user, and/or any other entities involved in the live conversation.

The method 300 proceeds from the operation 314 to an operation 316 for determining whether the request from the user has been fulfilled. For example, when the user has requested the automated assistant application to communicate certain information, or receive certain information, from a separate entity, and that information was communicated or received, the request from the user can be considered fulfilled. Therefore, regardless of whether the automated assistant transitioned to a different modality or not, the automated assistant can nonetheless fulfill the request from the user. In the instant example involving the neighborhood flower business, the automated assistant application can determine that the request has been fulfilled when the separate entity confirms the order placed on behalf of the user (e.g., “Thanks for your order! We will see you at 4:00 P.M.”). When the request is determined to have been fulfilled, the method 300 can proceed from the operation 316 to the operation 302 and/or any other suitable operation. Otherwise, when the automated assistant application is still operating in furtherance of fulfilling the request, the method 300 may proceed from the operation 316 to the operation 308 for continuing the live conversation and further of fulfilling the request.

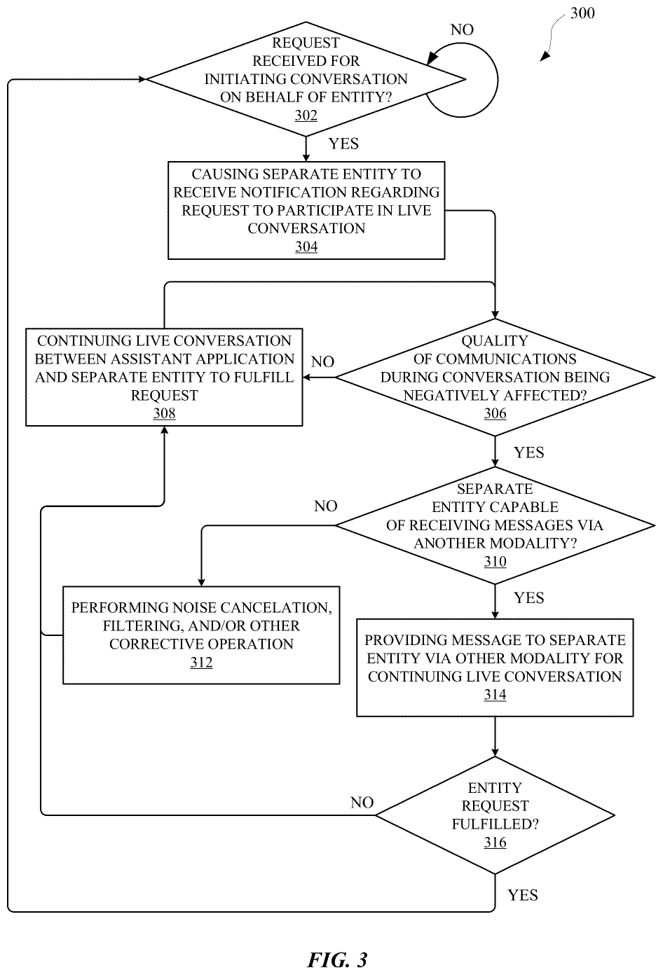

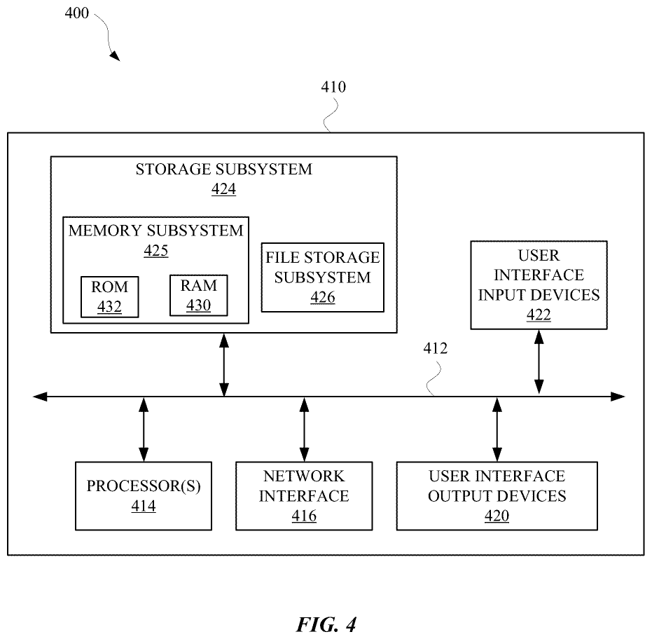

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided and includes: receiving, by an automated assistant application, a request for the automated assistant application to initiate a live conversation with a separate entity. The separate entity is different from an entity that provided the request to the automated assistant application. The method further includes: causing the separate entity to receive a notification that indicates the separate entity is being requested to participate in the live conversation with the automated assistant application; determining, during the live conversation, that an interference to the live conversation is estimated to affect an ability of the automated assistant application to accurately interpret content of the live conversation; determining, based on the interference to the live conversation, that the separate entity can participate in a separate conversation involving the automated assistant application sending a message to the separate entity; providing, by the automated assistant application, a particular message to the separate entity in furtherance of fulfilling the request; receiving, from the separate entity, a responsive message that includes information responsive to the request; and causing the information included in the responsive message to be provided for presentation to the entity in furtherance of fulfilling the request.

These and other implementations of technology disclosed herein can optionally include one or more of the following features.

In some implementations, the live conversation can include a phone call between the automated assistant application and the separate entity, and the particular message can include an SMS or other text-based message.

In some implementations, determining the interference to the live conversation is estimated to affect the ability of the automated assistant application to accurately interpret content of the live conversation can include: determining that an amount of background noise, and/or an amount of network bandwidth, is affecting the ability of the automated assistant application to accurately interpret content of the live conversation.

In some implementations, determining the interference to the live conversation is estimated to affect the ability of the automated assistant application to accurately interpret content of the live conversation can include: determining that inaccurate automatic speech recognition (ASR) is affecting the ability of the automated assistant application to accurately interpret content of the live conversation.

In some versions of those implementations, determining that the inaccurate ASR is affecting the ability of the automated assistant application to accurately interpret content of the live conversation can include: determining a degree of similarity between an expected ASR result and an actual ASR result does not satisfy a threshold degree of similarity.

In additional or alternative versions of those implementations, determining the interference to the live conversation is estimated to affect the ability of the automated assistant application to accurately interpret content of the live conversation can further include: determining that an amount of background noise, and/or an amount of network bandwidth, is further affecting the ability of the automated assistant application to accurately interpret content of the live conversation.

In some implementations, the notification can be an audible dial tone and/or a push notification rendered by the separate application.

In some implementations, the method can further include: causing the separate entity to receive a separate notification that requests confirmation of a phone number or other address for the separate entity to receive the message.

In some versions of those implementations, causing the separate entity to receive the separate notification that requests confirmation of the phone number or the other address can include: determining that information stored in association with the phone number or the other address satisfies a threshold similarity to other information stored in association with the separate entity.

In some implementations, the method can further include: providing, with the particular message or in a separate message, information communicated between the automated assistant application and the separate entity during the live conversation.

In some implementations, the particular message can include one or more selectable suggestions, and at least one selectable suggestion can include the information included in the responsive message from the separate entity to the automated assistant application.

In some implementations, the method can further include: causing the separate entity to receive a separate notification that requests the separate entity to indicate an availability of the separate entity to participate in a subsequent live conversation and/or the separate conversation.

In some implementations, a method implemented by one or more processors is provided and includes: participating in a live conversation with an automated assistant application via first modality. The automated assistant application participates in the live conversation on behalf of a separate entity. The method further includes receiving, from the automated assistant application, a particular message in furtherance of continuing the live conversation via a second modality that is different than the first modality. The particular message is provided by the automated assistant application based on the automated assistant application determining that the live conversation is being interrupted, or is expected to be interrupted. The method further includes providing, in response to receiving the particular message, a responsive message that indicates an availability of an entity to continue the live conversation via the second modality; and receiving, from the automated assistant application, a subsequent message that is in furtherance of continuing the live conversation and fulfilling a request provided by the separate entity to the automated assistant application.

These and other implementations of technology disclosed herein can optionally include one or more of the following features.

In some implementations, the first modality can include an audio call between the automated assistant application and the entity, and the second modality can include a text-based messaging modality.

In some versions of those implementations, the first modality can include an audio interface of a computing device operated by the entity, and the second modality can include a display interface of the computing device, or a different computing device, operated by the entity or a different entity.

In some implementations, the automated assistant application can determine that the live conversation is being interrupted, or is expected to be interrupted, by determining whether inaccurate automatic speech recognition (ASR) is affecting the ability of the automated assistant application to accurately interpret content of the live conversation.

In some implementations, a method implemented by one or more processors is provided and includes: receiving, by an automated assistant application, a request for the automated assistant application to initiate a live conversation with a separate entity. The separate entity is different from an entity that provided the request to the automated assistant application, and the automated assistant application is accessible via a computing device that is operated by the entity. The method further includes causing, by a server device associated with the automated assistant application, the separate entity to receive a notification that indicates the separate entity is being requested to participate in the live conversation with the automated assistant application. The notification is rendered at a separate computing device that is operated by the separate entity. The method further includes: determining, by the server device, that an interference to the live conversation is estimated to affect an ability of the automated assistant application to accurately interpret content of the live conversation; determining, by the server device, based on the interference to the live conversation, that the separate entity can continue the live conversation via a separate modality; and providing, by the server device, a particular message to the separate entity in furtherance of fulfilling the request. The particular message is rendered via an instance of the separate modality of the separate computing device or another computing device. The method further includes: receiving, at the computing device and via the separate modality, a responsive message that includes information responsive to the request; and causing, by the automated assistant application, the information included in the responsive message to be rendered, via the separate modality, to the entity in furtherance of fulfilling the request.

These and other implementations of technology disclosed herein can optionally include one or more of the following features.

In some implementations, the live conversation can include a video call between the automated assistant application and the separate entity, and the particular message includes an audio message or other audio data.

In some implementations, determining the interference to the live conversation is estimated to affect the ability of the automated assistant application to accurately interpret content of the live conversation can include: determining that an amount of image resolution is affecting the ability of the automated assistant application to accurately interpret content of the live conversation.

In some implementations, determining the interference to the live conversation is estimated to affect the ability of the automated assistant application to accurately interpret content of the live conversation can include: determining that inaccurate automatic speech recognition (ASR) is affecting the ability of the automated assistant application to accurately interpret content of the live conversation.

In addition, some implementations include systems having one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to execute any of the aforementioned instructions. Some implementations also include one or more non-transitory computer readable storage media storing computer instructions executable by one or more processors to perform any of the aforementioned instructions Some implementations also include a computer program product including instructions executable by one or more processors to perform any of the aforementioned instructions. Some implementations also include a method implemented by one or more processors to perform any of the steps of the aforementioned instructions.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A method implemented by one or more processors, the method comprising:
receiving, by an automated assistant application, a request for the automated assistant application to initiate a live conversation with a separate entity,
wherein the separate entity is different from an entity that provided the request to the automated assistant application;
causing the separate entity to receive a notification that indicates the separate entity is being requested to participate in the live conversation with the automated assistant application;
determining, during the live conversation, that an interference to the live conversation is estimated to affect an ability of the automated assistant application to accurately interpret content of the live conversation;
determining, based on the interference to the live conversation, that the separate entity can participate in a separate conversation involving the automated assistant application sending a message to the separate entity;
providing, by the automated assistant application, a particular message to the separate entity in furtherance of fulfilling the request;
receiving, from the separate entity, a responsive message that includes information responsive to the request; and
causing the information included in the responsive message to be provided for presentation to the entity in furtherance of fulfilling the request.

2. The method of claim 1, wherein the live conversation includes a phone call between the automated assistant application and the separate entity, and the particular message includes an SMS or other text-based message.

3. The method of claim 1, wherein determining the interference to the live conversation is estimated to affect the ability of the automated assistant application to accurately interpret content of the live conversation includes:
determining that an amount of background noise, and/or an amount of network bandwidth, is affecting the ability of the automated assistant application to accurately interpret content of the live conversation.

4. The method of claim 1, wherein determining the interference to the live conversation is estimated to affect the ability of the automated assistant application to accurately interpret content of the live conversation includes:
determining that inaccurate automatic speech recognition (ASR) is affecting the ability of the automated assistant application to accurately interpret content of the live conversation.

5. The method of claim 4, wherein determining that the inaccurate ASR is affecting the ability of the automated assistant application to accurately interpret content of the live conversation includes:
determining a degree of similarity between an expected ASR result and an actual ASR result does not satisfy a threshold degree of similarity.

6. The method of claim 4, wherein determining the interference to the live conversation is estimated to affect the ability of the automated assistant application to accurately interpret content of the live conversation further includes:
determining that an amount of background noise, and/or an amount of network bandwidth, is further affecting the ability of the automated assistant application to accurately interpret content of the live conversation.

7. The method of claim 1, wherein the notification is an audible dial tone and/or a push notification rendered by the separate application.

8. The method of claim 1, further comprising:
causing the separate entity to receive a separate notification that requests confirmation of a phone number or other address for the separate entity to receive the message.

9. The method of claim 8, wherein causing the separate entity to receive the separate notification that requests confirmation of the phone number or the other address includes:
determining that information stored in association with the phone number or the other address satisfies a threshold similarity to other information stored in association with the separate entity.

10. The method of claim 1, further comprising:
providing, with the particular message or in a separate message, information communicated between the automated assistant application and the separate entity during the live conversation.

11. The method of claim 1, wherein the particular message includes one or more selectable suggestions, and at least one selectable suggestion includes the information included in the responsive message from the separate entity to the automated assistant application.

12. The method of claim 1, further comprising:
causing the separate entity to receive a separate notification that requests the separate entity to indicate an availability of the separate entity to participate in a subsequent live conversation and/or the separate conversation.

13. A method implemented by one or more processors, the method comprising:
participating in a live conversation with an automated assistant application via first modality,
wherein the automated assistant application participates in the live conversation on behalf of a separate entity;
receiving, from the automated assistant application, a particular message in furtherance of continuing the live conversation via a second modality that is different than the first modality,
wherein the particular message is provided by the automated assistant application based on the automated assistant application determining that the live conversation is being interrupted, or is expected to be interrupted;
providing, in response to receiving the particular message, a responsive message that indicates an availability of an entity to continue the live conversation via the second modality; and
receiving, from the automated assistant application, a subsequent message that is in furtherance of continuing the live conversation and fulfilling a request provided by the separate entity to the automated assistant application.

14. The method of claim 13, wherein the first modality includes an audio call between the automated assistant application and the entity, and the second modality includes a text-based messaging modality.

15. The method of claim 14, wherein the first modality includes an audio interface of a computing device operated by the entity, and the second modality includes a display interface of the computing device, or a different computing device, operated by the entity or a different entity.

16. The method of claim 13, wherein the automated assistant application determines that the live conversation is being interrupted, or is expected to be interrupted, by determining whether inaccurate automatic speech recognition (ASR) is affecting the ability of the automated assistant application to accurately interpret content of the live conversation.

17. A method implemented by one or more processors, the method comprising:
receiving, by an automated assistant application, a request for the automated assistant application to initiate a live conversation with a separate entity,
wherein the separate entity is different from an entity that provided the request to the automated assistant application, and
wherein the automated assistant application is accessible via a computing device that is operated by the entity;
causing, by a server device associated with the automated assistant application, the separate entity to receive a notification that indicates the separate entity is being requested to participate in the live conversation with the automated assistant application,
wherein the notification is rendered at a separate computing device that is operated by the separate entity;
determining, by the server device, that an interference to the live conversation is estimated to affect an ability of the automated assistant application to accurately interpret content of the live conversation;
determining, by the server device, based on the interference to the live conversation, that the separate entity can continue the live conversation via a separate modality;
providing, by the server device, a particular message to the separate entity in furtherance of fulfilling the request,
wherein the particular message is rendered via an instance of the separate modality of the separate computing device or another computing device;
receiving, at the computing device and via the separate modality, a responsive message that includes information responsive to the request; and
causing, by the automated assistant application, the information included in the responsive message to be rendered, via the separate modality, to the entity in furtherance of fulfilling the request.

18. The method of claim 17, wherein the live conversation includes a video call between the automated assistant application and the separate entity, and the particular message includes an audio message or other audio data.

19. The method of claim 17, wherein determining the interference to the live conversation is estimated to affect the ability of the automated assistant application to accurately interpret content of the live conversation includes:
determining that an amount of image resolution is affecting the ability of the automated assistant application to accurately interpret content of the live conversation.

20. The method of claim 17, wherein determining the interference to the live conversation is estimated to affect the ability of the automated assistant application to accurately interpret content of the live conversation includes:
determining that inaccurate automatic speech recognition (ASR) is affecting the ability of the automated assistant application to accurately interpret content of the live conversation.
